(19) United States
(12) Patent Application Publication
(10) Pub. No.: US 2005/0103821 A1
(43) Pub. Date: May 19, 2005

(54) Type-flexible unit for the efficient welding of the essential components of a vehicle chassis on production of the prototype thereof

(76) Inventors: Norbert Bossert, Weil im Schoenbuch (DE); Achim Maeutner, Wildberg (DE); Werner Nuber, Sindelfingen (DE); Roland Windheim, Boeblingen (DE)

Correspondence Address: CROWELL & MORING LLP;INTELLECTUAL PROPERTY GROUP, P.O. BOX 14300, WASHINGTON, DC, 20044-4300, US

(21) Appl. No.: 10/497,072

(22) PCT Filed: Oct. 4, 2002
(86) PCT No.: PCT/EP02/11146

(30) Foreign Application Priority Data
Nov. 28, 2001 (DE) 101 58 264.1

(51) Int. Cl. B23K 1/00

(52) U.S. Cl. 228/101

(57) ABSTRACT

An installation is provided for the precise mutual alignment and welding together of the main components of a vehicle body to form a complete body shell during production of the prototype thereof. The components of the prototype body are joined in precise position in a first tacking station, which can be closed in the manner of a cage, and tacked through the openings in the cage. In a subsequent welding station, the tacked sheet-metal parts of the body, which is now only supported on the underside, but otherwise freely accessible on all sides, are fully welded together. This division of the work makes prototype production efficient and ergonomically very favorable. The individual parts and installation components of the production installation are formed as far as possible as modular elements standardized to conform to the system, which on account of a gridwork of insertion and connection openings can be assembled in various configurations rapidly and nevertheless in precise position and can be used universally, i.e. type-independently, whereby the installation can also be type-flexibly converted. The individual installation components are formed type-specifically only to the extent absolutely required, the type-specific receiving units assembled from multiple parts for their part largely comprising universally usable parts.

### BACKGROUND AND SUMMARY OF THE INVENTION

The invention relates to an installation for the precise mutual alignment and welding together of the main components of a vehicle body to form a complete body shell during production of the prototype thereof.

In the body-shell production of vehicle bodies, first of all components such as the vehicle floor, front end, rear end, right/left interior side wall, right/left exterior side wall, are welded together from the sheet-metal parts of the body, irrespective of whether the bodies are manufactured in series production or as a prototype, it being possible for this enumeration or subdivision into components to differ according to the vehicle type. The subdivision of a vehicle body into individual components is fixed by the designer at a very early design stage of the vehicle development on the basis of experience and in agreement with various departments of a vehicle manufacturer concerned with the vehicle development and production.

The individual components are for their part assembled from a number of sheet-metal parts, which in their initial state are simply of a size allowing them to be handled manually. On account of this moderate size of the individual sheet-metal parts of the components and on account of the open or even flat form of construction of the individual components, individual sheet-metal parts can be fixed in precise position with respect to one another within a component and connected to one another by welding points in relatively simple devices. More problematical, however, is the joining together of the various components to form a complete body, to be precise because of the way in which the size and weight makes the various components unwieldy and because the body as a whole is a voluminous shell.

During the development time of a vehicle, prototypes of the vehicle to be developed, constructed and assembled to varying degrees of completion, are forever being required for different purposes. The further a specific vehicle type has progressed in its development, the more prototype copies of this vehicle type are required, because the more departments within the company of a vehicle manufacturer have to carry out studies on an actual exemplary embodiment of this vehicle type. While the very first trial models of the vehicle type are still produced largely by using equipment which is universally suitable for use but not highly specialized, and at the same time an extremely high level of working effort and not yet optimum production accuracy can be accepted, at least in the final phase of the development, in which a greater number of prototype copies are required, the proportion of type-specific devices in prototype production is particularly high. Although this means that the working effort can be reduced in comparison with the largely manual production of the first model and the production accuracy can be increased, this can only be at the expense of considerable effort with respect to the design, production of parts and assembly of a largely type-dedicated production station. The time and cost to be expended on this have an adverse effect on the investment side on the unit costs of the prototype copies and on the scheduling for making them. In spite of extensive use of type-specifically designed device parts, the yield of such a prototype production installation is nevertheless only modest.

DE 35 25 851 C2 shows a receiving unit assembled from multiple parts for use in an installation for producing the prototype of first-model bodies. The known receiving unit is assembled in its main parts from contour-lasered sheets. Moreover, the receiving unit that has been adapted to the vehicle type to be produced is designed in such a way that, in spite of an individual overall design, many of its individual parts can be used again after the receiving unit is dismantled. A number of receiving units individually designed to correspond to the body form at the clamping location are fixed and securely bolted on a planar base plate and project up from it at right angles. The receiving units are arranged on the base plate in such a way that the various welded-together components and large parts of the vehicle body produced can be received and fixed in the receiving units in precise positions. The known literature reference is restricted to a type-flexible design of the required receiving units themselves, but does not include any indication as to whether, or if so how, side walls can be received in precise position in a production device.

On the basis of this prior art, the object of the invention is to present an installation for production of the prototype of body shells in which all the advantages stated below can be achieved in their entirety:

Firstly, the preliminarily required level of investment in terms of time and money until prototypes of a specific vehicle type can actually be produced is to be lower than before.

Furthermore, the proportion of type-specific components of such a prototype production installation is to be lower than before and the production installation is consequently to be provided with greater flexibility with respect to different vehicle types.

In addition, the prototype production is in principle also to allow a greater closeness to or closer relationship with the later series production than before, so that studies with respect to series production are also possible at the stage of prototype production.

Finally, the prototype production itself is to be more efficient than before.

This object is achieved according to the invention by a prototype production installation which is formed in accordance with all the features of claim 1.

According to the invention, the idea of dividing up the required extent of work among a number of workstations, an idea known per se from series production, is adopted in the present case in a special, prototype-specific way for prototype production. To be precise, the components of the prototype body are joined in precise position in a first tacking station, which can be closed in the manner of a cage, and tacked through the openings in the cage. In a subsequent welding station, the body parts, already tacked in precise position, of the body, which is then already intrinsically stable and now only supported on the underside, but otherwise freely accessible on all sides, are fully welded together. This division of the work not only brings prototype production close to series production but makes prototype production efficient and ergonomically very favorable, because the greater number of welding points required can be performed on the freely accessible body. The installation for prototype production is assembled from various individual parts and installation components, which are largely formed as modular elements standardized to conform to the system, which on account of a gridwork of insertion and connection openings can be assembled in various configurations rapidly and nevertheless in precise position. On account of the reusable parts, this not only allows the installation to be constructed at low cost and in a short time but also to be type-flexibly converted to the production of a different vehicle type. Meaningfully dividing up the individual installation components and device parts in the way according to the invention, on the one hand into parts which can be used universally, i.e. type-independently, and on the other hand into parts which can only be used type-specifically, i.e. only for a specific vehicle type, provides the required production accuracy and efficiency of the installation, the type-specific receiving units assembled from multiple parts for their part largely comprising universally usable parts.

Expedient refinements of the invention can be taken from the subclaims; otherwise, the invention is further explained below on the basis of an exemplary embodiment represented in the drawing.

### DETAILED DESCRIPTION OF THE DRAWINGS

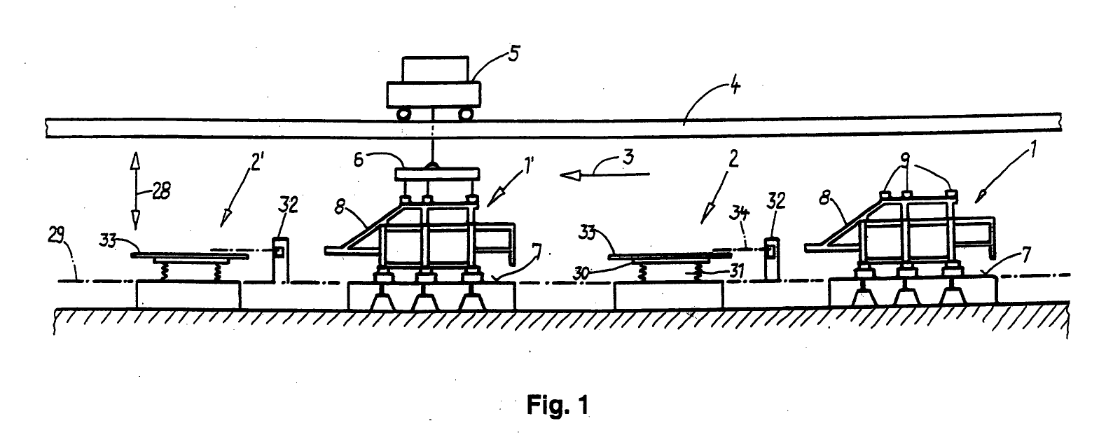

FIG. 1 shows a lateral overall view of the installation for the production of prototype body shells,

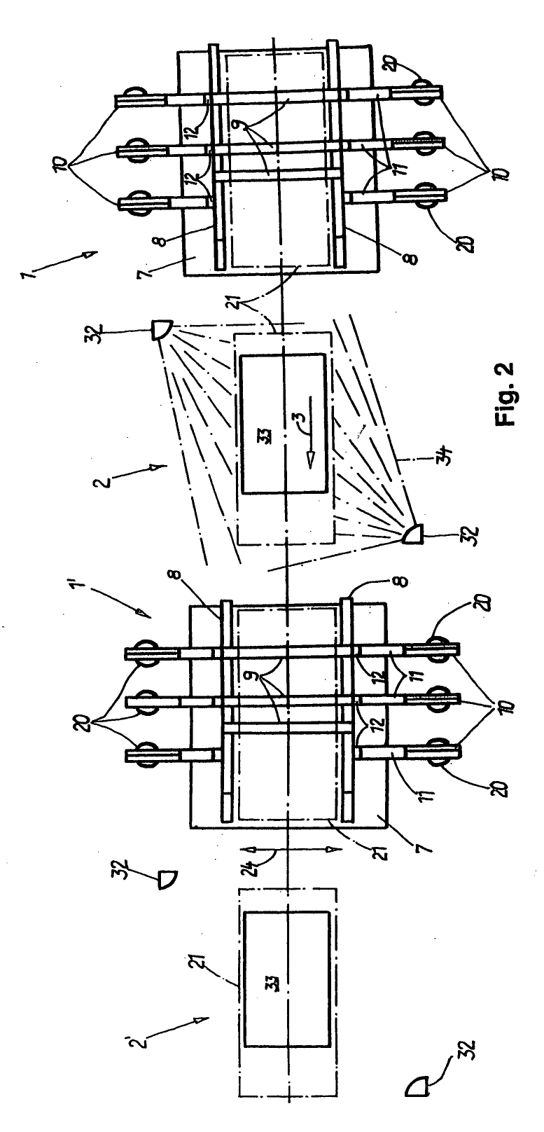

FIG. 2 shows a horizontal projection of the installation according to FIG. 1,

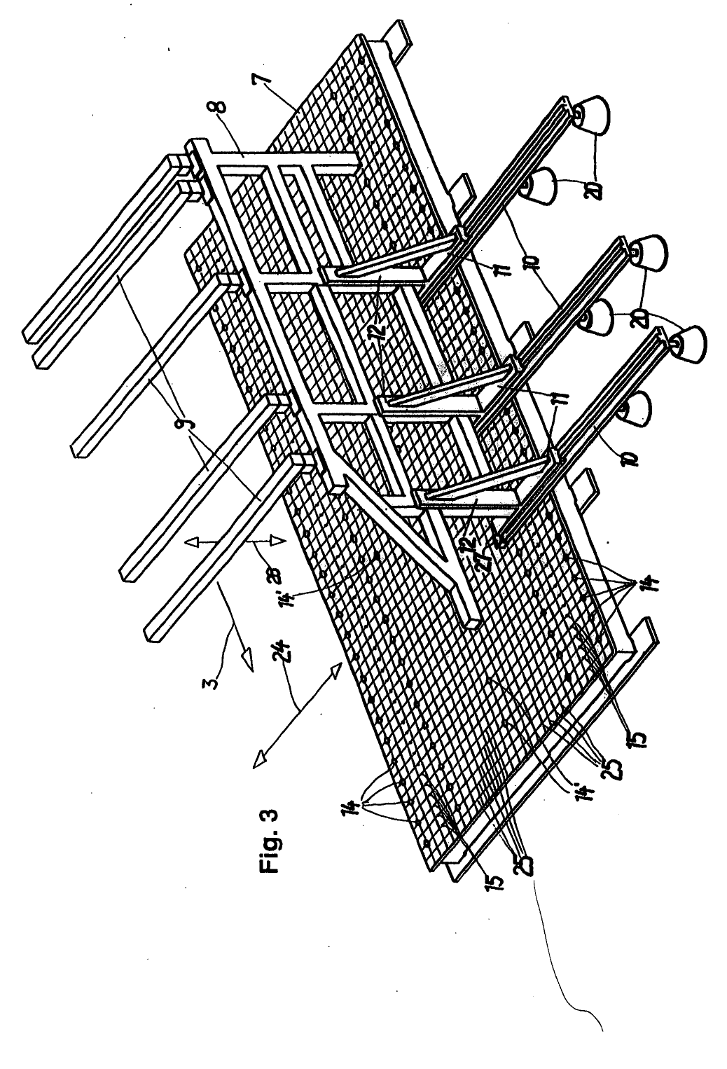

FIG. 3 shows a partial, perspective representation of the tacking station of the installation according to FIGS. 1 and 2,

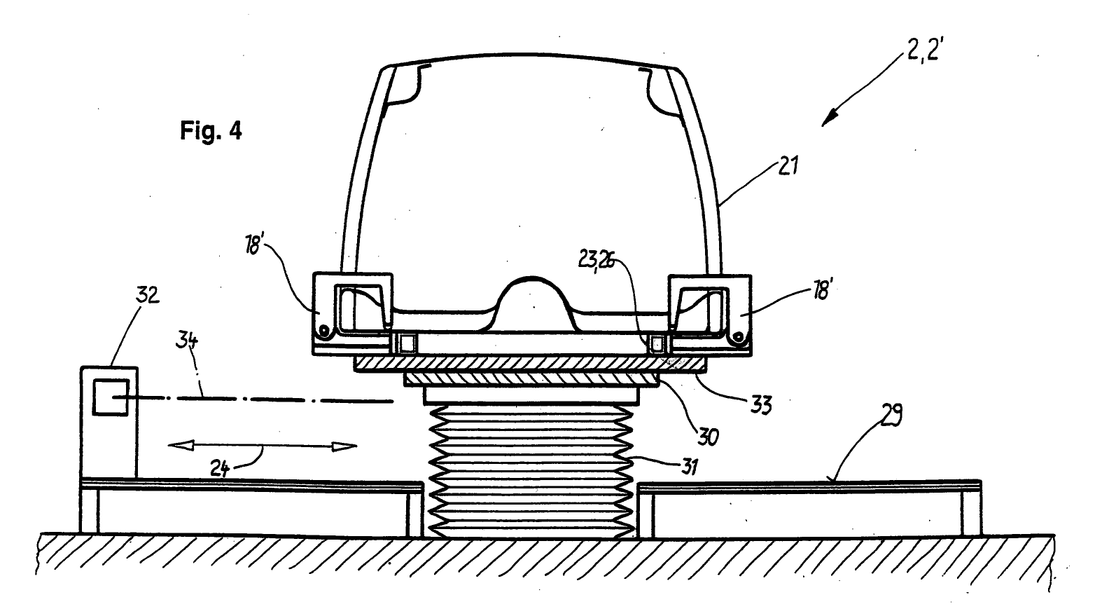

FIG. 4 shows an individual view of the welding station of the installation according to FIGS. 1 and 2,

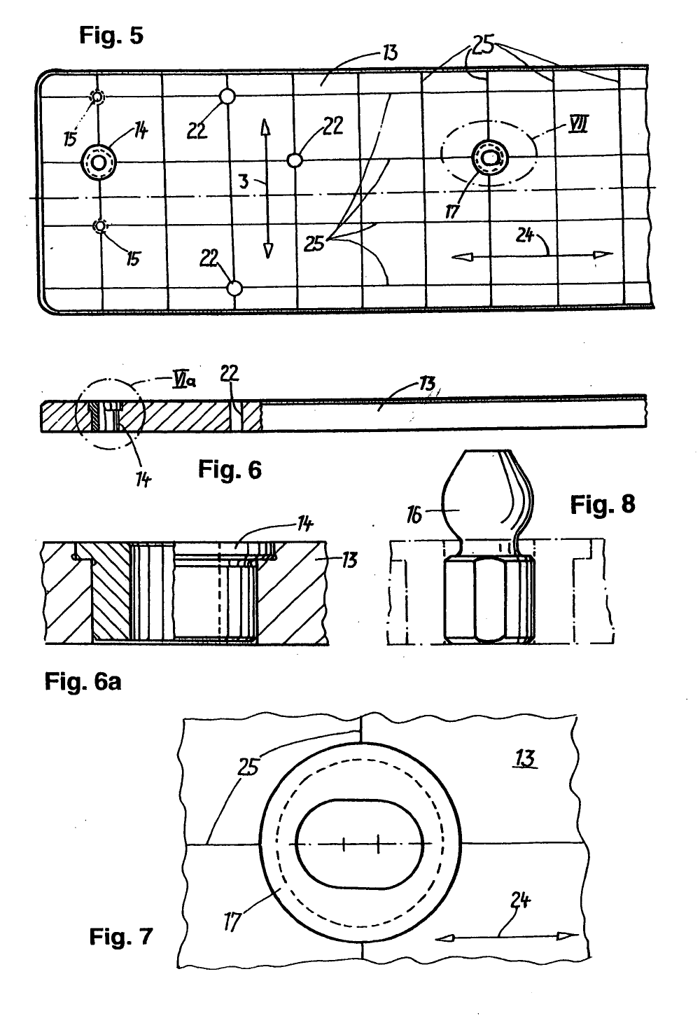

FIGS. 5 and 6 show a plan view (FIG. 5) and cross section (FIG. 6) of and through a mounting plate provided with sockets, threaded holes and system lines,

FIG. 6a shows an enlarged representation of the detail VIa from FIG. 6,

FIG. 7 shows an enlarged representation of the detail VII from FIG. 5, that is an axial view of the socket formed as an elongate hole to compensate for thermal expansions,

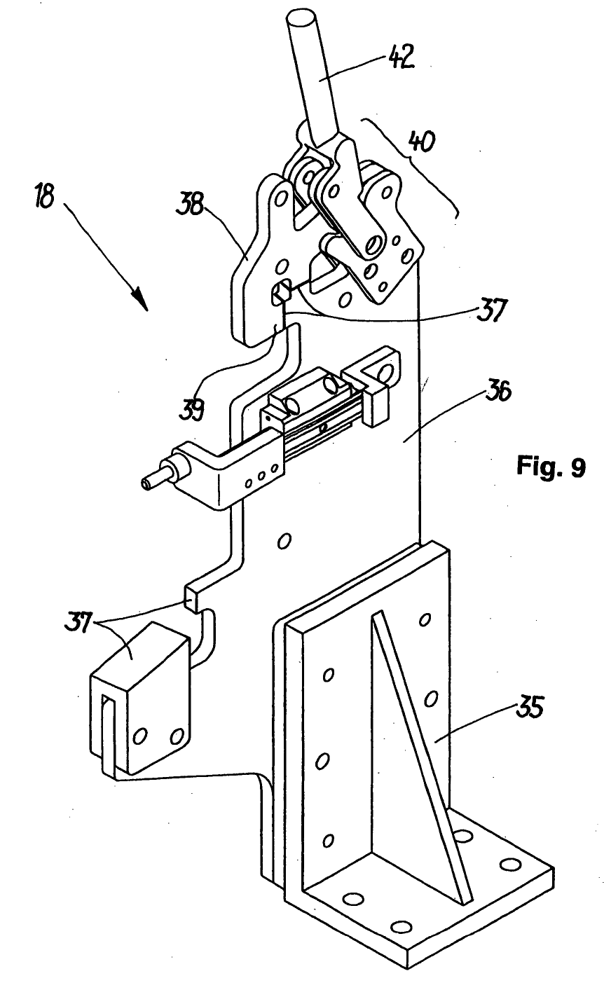

FIG. 8 shows an individual representation of a spigot,

FIG. 9 shows a perspective individual representation of a receiving unit and

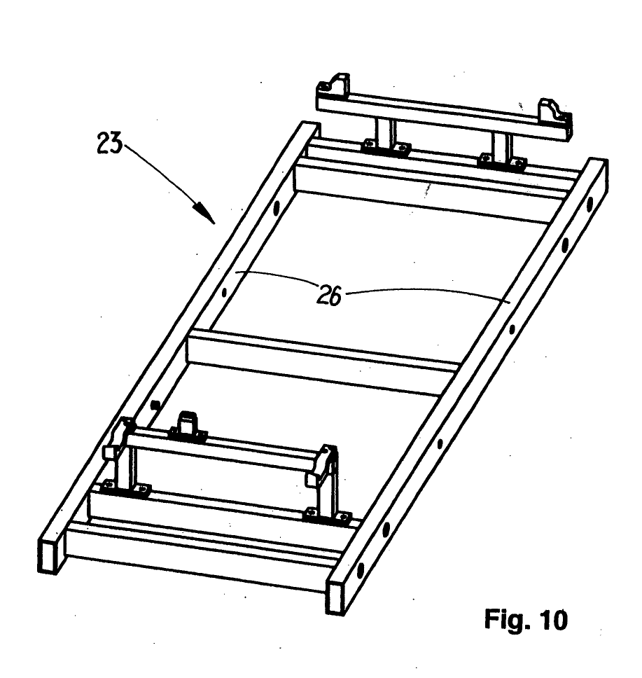

FIG. 10 shows a perspective representation of a carrying skid for transporting the body set down on it.

### DETAILED DESCRIPTION OF THE DRAWINGS

The prototype production installation represented in FIGS. 1 and 2 for vehicle bodies 21 presupposes that all the main components or large parts of the body—referred to hereafter as “components” for short—have been separately prefabricated. The following description does not go into this. It is intended that these prefabricated components are mutually aligned precisely and welded together to form a complete body shell by the production installation represented.

Although prototype bodies with a greater or lesser number of advantages and disadvantages have also already been manufactured in the past by corresponding production installations, all the advantages stated below are achieved in their entirety by the prototype production installation according to the invention which is described below:

Efficient prototype production.

Low preliminarily required expenditure in terms of time and money until prototypes of a specific vehicle type can actually be produced.

Low proportion of type-specific components of such a prototype production installation and consequently greater flexibility of the production installation with respect to different vehicle types.

In principle, great closeness to or close relationship with the later series production, with the possibility of studies with respect to series production already during prototype production.

To be able to achieve this complete set of advantages, according to the invention the prototype production installation is provided with the following design features:

In the case of the exemplary embodiment represented in FIGS. 1 and 2, two pairs of stations 1, 2 and 1′, 2′ are arranged one behind the other in the longitudinal direction 3 in a production line, and are connected to one another in transporting terms by a conveying device—for example by a craneway 4. Of the two pairs of workstations 1, 2 and 1′, 2′, the first workstation 1, 1′ respectively in the running-through direction 3 serves for the mutual alignment and tacking of the components, for which reason it is referred to hereafter as the tacking station. In the workstation 2, 2′ respectively arranged in second position, the already tacked components are fully welded, for which reason these second workstations are referred to hereafter as the welding station. The conveying device for connecting the workstations 1, 2, 1′, 2′ in transporting terms is formed as a gantry crane installation with an elevated craneway 4 and a traveling crane 5 running on it. The crane tackle 6 attached to the load hook comprises a cross member running in the longitudinal direction 3, with load-bearing cables attached to both ends.

In the case of the exemplary embodiment represented, two pairs of stations 1, 2 and 1′, 2′, respectively comprising a tacking station 1 or 1′ and a welding station 2 or 2′, are arranged directly one behind the other in the production line linked up in transporting terms. In this case, the first pair of stations 1, 2 is formed for the mutual alignment and tacking of the components including the right and left side walls, arranged in the interior of the body 21, and the second pair of stations 1′, 2′ is formed for the subsequent alignment and tacking of the two exterior side walls.

The components of the body, or the partially completed body, rest on a carrying skid 23 constructed in a frame-like manner while they are being transported into the first station 1 or between successive workstations. The vehicle body 21 produced is accepted and secured on it with vertical play but prevented from slipping horizontally. Two longitudinally running frame legs 26 of the carrying skid 23 respectively protrude beyond the vehicle body 21 at the front and rear in the longitudinal direction and are provided at the ends with lugs for attaching crane tackle.

The tacking station 1, 1′, a portion of which is represented enlarged in FIG. 3, has on the underside a horizontal, planar base plate 7 and to the right and left in each case a vertical side wall 8, formed as a framework of bars. The side walls are movable in the transverse direction 24 on horizontal guiding rails 10 and can be made to move between a lockable working position on the one hand and a moved-away loading position on the other hand. In the moved-together state of the side walls 8, they can be connected at the upper side by detachable and fixable connecting bars 9 to form a dimensionally stable cage. Both the base plate 7 and the two side walls 8 are provided with a multiplicity of receiving units 18, which have been adapted to the vehicle type to be produced, for the positionally defined reception and secure clamping of the components within the tacking station 1, 1′. Further details of the tacking station are not to be discussed any more specifically until further below.

The welding station 2, 2′ likewise has on the underside a horizontal, planar mounting plate 30, which is likewise provided with a multiplicity of receiving units 18′ adapted to the vehicle type to be produced. By means of these receiving units, the body shell already tacked together from the components, bearing its own weight and the forces occurring while it is being worked without deforming, can be received in a positionally defined manner and securely clamped within the welding station 2, 2′. The receiving units 18′ of the welding station are restricted to the underside of the body shell 21 to be clamped, so that the body shell 21 received in the welding station 2, 2′ is freely accessible from the sides, from the front, from the rear and from above.

Both the tacking station 1, 1′ and the welding station 2, 2′ include on the one hand installation components and device parts which can be used universally, i.e. type-independently, and on the other hand installation components and device parts which can be used type-specifically, i.e. only for a specific vehicle type.

The installation components or device parts stated below of the tacking station 1, 1′ are formed in the following way for the purpose of universal usability of these components or parts. These are to a certain extent parts of a modular system, from the different standardized “modules” of which workstations for various forms of body can be assembled in a rapid and flexible way.

The base plate 7 represented in more detail in FIG. 3 is provided with a multiplicity of sockets 14, 17 arranged in a regular gridwork and threaded bores 15 arranged in between, in a way corresponding to the same gridwork. In the case of the exemplary embodiment represented, the decisive gridwork is formed in an orthogonal manner and has the same grid spacing in the horizontal longitudinal direction 3 and transverse direction 24 and also in the vertical direction 28—which is to be discussed once again further below. The sockets are very precisely worked and have been embedded into the base plate with the same precision. One type of socket 14 (shown enlarged in FIG. 6a) is provided with a cylindrical insertion opening; it serves for fixing the assembly parts free from play on all sides. Another type of socket 17 (FIG. 7) has an oval insertion opening, i.e. formed as an elongate hole; this socket serves for compensating thermally induced expansion. The oval sockets have been embedded into the mounting plate in such a way that the long axis of the oval extends parallel to the transverse direction 24. By means of the sockets 14, 17 and the spigots 16, which are shown by way of example in FIG. 8 and exactly fit the sockets, the main components of the workstations can be assembled with little play and very accurately and efficiently in a desired configuration. The fitted-together parts can also be securely bolted to one another through prepared threaded bores 15 or corresponding through-holes 22 in the mounting plates 13 (for example FIGS. 5 and 6). The spigots 16 (FIG. 8) are cylindrically formed in their lower part and are inserted with this part into a socket of the assembly base, i.e. of the mounting plate or the assembly tree. Although the upper part of the spigot is likewise formed in a rotationally symmetrical manner and such that it is exactly the same as the cylindrical part in its—greatest—diameter, the upper part of the spigot is formed in principle in a spherical manner with a frustrum of a cone on top, that is to say like an onion, in order to facilitate the fitting on of a difficult component.

To be able to find more easily the desired assembly position of the parts to be assembled, straight system lines 25 following the gridwork are machined in the base plate 7 or in the mounting plate 30 of the tacking station 1, 1′ and the welding station 2, 2′ and in the mounting plate 13 or adapter plate 33 of both stations 1, 1′; 2, 2′. In the case of the exemplary embodiment represented, the machined system lines 25 run centrally through the sockets 14, 17 and the threaded bores 15.

Embedded in the middle part of the surface of the base plate 7 are at least three separate sockets, which are known exactly in respect of their position and lie for example at the corner points of an equilateral or isosceles triangle. These sockets need not dimensionally coincide with the sockets 14 already mentioned, because they serve a different purpose. To be precise, it is intended that a measuring instrument for spatially measuring the decisive points of the tacking station 1, 1′ can be inserted into these special sockets, so that a reference base for such a measuring operation is provided by the special sockets.

Various rectangular, mounting plates 13, of various widths and/or lengths and machined such that they are plane-parallel, are kept ready, one of which is shown by way of example in FIGS. 5 and 6. These mounting plates are also provided with sockets 14, 17 arranged to conform to a gridwork and with threaded through-holes 22, and consequently can readily be assembled rapidly and in precise position in various arrangements on the base plate 7 using spigots 16 and bolts. The mounting plates are intended for receiving a group of receiving units 18. The horizontal outside dimensions of the mounting plates 13 are made to correspond in the longitudinal direction 3 and transverse direction 24 to the mentioned gridwork, which is decisive for the position of the sockets 14, 17 and threaded bores 15. What is more, the sockets 14, 17 and threaded bores 15 in the mounting plates 13 are arranged eccentrically by half the grid spacing in relation to the delimiting edge of the mounting plates 13 lying parallel to the transverse direction 24. This allows the mounting plates to be fixed by means of the sockets and spigots by turning them into a longitudinal or transverse position staggered by half the grid spacing.

On both of the longitudinal sides of the base plate 7, guiding rails 10 smoothly formed on the underside are mounted mirror-symmetrically on the latter and are likewise provided with sockets 14, 17 matching the gridwork of the base plate 7 and bolt through-holes 22. In the case of the exemplary embodiment represented, there are three guiding rails on each side. The guiding rails 10 mounted on both of the longitudinal sides of the base plate 7 protrude laterally beyond the base plate 7 and are supported in the protruding part on the factory floor by separate, height-adjustable supports 20. The space between the protruding guiding rails is freely accessible on foot by means of a raised floor 29 (FIG. 4).

A carriage 11 can be made to move on each of the guiding rails 10. Respectively arranged on each carriage is a vertically rising-up, flexurally rigidly supported assembly tree 12, which laterally has a vertical flat side facing the base plate 7. Arranged in the assembly tree are at least two sockets 14, 17, corresponding to the said gridwork in the vertical direction 28, and threaded bores 15 for the assembly of the framework-like side walls 8. The sockets 14, 17, attached to the assembly tree to conform to the gridwork in the vertical direction, are arranged as a reference plane above the surface of the base plate 7 by an integral multiple of the grid spacing, taking into account the common overall height of the guiding rails 10 mounted laterally on the longitudinal sides of the base plate 7 and taking into account the carriage 11 which can be made to move on said rail. As a result, exact positioning in height of the framework-like side walls 8 to be mounted on the assembly tree is also made easier.

The working position of the framework-like side wall 8 which can be made to move on the guiding rails 10 and the carriage 11 is dimensionally determinative for the joining accuracy of the components of the body produced, and therefore secured by stops 27 mounted on the base plate 7. What is more, the working position predetermined in this way is secured by a tensioner. The opposite end of the horizontal traveling path, the loading position, need not be precisely predetermined and secured; it merely has to be ensured that the carriage 11 does not run out beyond the ends of the guiding rail.

The guide between the carriage and the guiding rail is formed as a precise and smooth-running rolling bearing guide. It must be precise because it determines the position in terms of height of the side walls, and consequently the joining accuracy for the components. It must be smooth-running, in order that the heavy parts, weighing tonnes, can be manually moved by the worker without great exertion of force. The traveling path of the framework-like side walls 8 carried by the guiding rails 10 and the carriages 11 between the working position and the moved-away loading position is at least approximately 60 cm, but preferably approximately 1 m or more. The possibility of moving the side walls 8 away from the body provides a space which can be comfortably accessed by the worker on foot between the mounting plates, carrying the body produced, and the receiving units respectively rising up from them, on the one hand, and the side walls 8, on the other hand, which makes ergonomically favorable and rapid working possible.

In addition to the stated, standardized modular parts, which can be identically used for the construction of one or another production installation, the tacking station 1, 1′ also requires further installation components and device parts, which however can only be used type-specifically, that is to say cannot be used in a dimensionally identical form—apart from exceptions—for the construction of a different production installation. Although these parts are generally similarly formed in principle, they differ with respect to their dimensions or exact form.

First to be mentioned in this connection are the right and left, framework-like side walls 8, which are respectively formed as two distortion-resistant bar frameworks that are mirror-symmetrical to each other. The assembly bars of this bar framework leave open apertures suitable for welding tools to pass through. What is more, the line followed by the bar is in each case broadly adapted to the line taken by the lateral contours and to the position of the A, B and/or C pillars of the vehicle type to be produced. The two opposite, vertical flat sides of the bar frameworks are respectively machined such that they are plane-parallel. To allow the framework-like side walls to be mounted onto the standardized assembly trees 12 of the transversely movable carriages 11 to conform to the gridwork, the side walls also have on the flat side facing the assembly trees 12 sockets 14, 17, arranged to conform to the gridwork, and threaded bores 15. On their upper side, the side walls are plane-machined in a horizontal plane and provided there, at locations corresponding to the number and the required mounting position of the connecting bars 9, with a socket or spigot and with a connecting element.

The connecting bars 9, corresponding in their lengths to the spacing between the side walls 8 locked in the working position, are also parts which can only be used type-dependently. They are plane-machined on the underside at the ends and provided there with a spigot or a socket and with a connecting element for connection on the upper side to the side walls 8. The connecting elements between the connecting bars 9 and the two opposite side walls 8 are respectively formed as quick-action closures. The connecting bars 9 must be detached whenever a fully tacked body is changed, and reassembled after the components for a new body have been introduced into the tacking station 1, 1′.

It goes without saying that the many receiving units 18 which have been adapted to the vehicle type to be produced (FIG. 9) are also formed as type-dependent special parts. The receiving units are mounted directly on the side walls 8 or indirectly with the interposition of bottom mounting plates 13 or an adapter plate 33 on the base plate 7 or mounting plate 30 and project at right angles from them. The receiving units are respectively provided with a number of adapted receiving locations 37 and a movable clamping arm 38. In the case of the receiving units mounted at the bottom, it must be taken into account that intermediate spaces remain between them in such a way that, to accept the vehicle body 21 produced, the frame legs 26 of the carrying skid 23 can be lowered in the vertical direction 28 into the intermediate spaces and lifted out of them without hindrance.

The receiving units 18, 18′ adapted to the vehicle type to be produced—an exemplary embodiment is represented in FIG. 9—for the positionally defined reception and secure clamping of the components within the individual workstations 1, 2; 1′, 2′ are in principle constructed identically to one another and respectively comprise the following components.

Provided as a foot is a fastening angle 35, which is identically formed for all the receiving units 18, 18′ and can be bolted onto the load-bearing underlying surface. Bolted onto this fastening angle 35 is a supporting plate 36, which projects from the load-bearing underlying surface and is formed with its contour that is facing the vehicle body 21 individually in a way corresponding to the respective local outline contour of the body part on the outer side of the latter, and is in “point” contact with the latter at at least two receiving locations 37 on a small area which is sometimes arranged at a spatial angle. The length of the supporting plate 36 from the fastening angle 35 to the punctiform receiving locations 37 corresponds to the individually required distance of the body part from the load-bearing underlying surface. This supporting plate can be cut out from a metal sheet efficiently and with exact contours by means of a data-controllable laser cutting installation, using data on the form or shape of the body that are today generally available as a set of data, it even being possible to incorporate a spatially angled formation of the bearing surface of the receiving locations 37. A small machining allowance for finishing work is provided at the receiving locations. Only the final fine-machining of the receiving locations is performed to the actual final dimensions and the final form of the same, as a separate operation.

Pivotably fastened to the end of the supporting plate 36 on the body side is a clamping arm 38, which can be closed or opened by a tensioner 40 provided with a handle 42. In the closed state, shown in FIG. 9, the clamping arm reaches in a jaw-like manner over the body part to be securely clamped. It is individually shaped on its inner side in a way corresponding to the respective local outline contour of the body part. At locations of the clamping arm which correspond in the closed state to a receiving location 37 of the supporting plate 36, the clamping arm is respectively provided with a shape-adapted clamping thumb 39.

Before they are assembled individually in a way corresponding to the desired position in each case of a receiving unit to be mounted, precision bores with an axially adjoining nut thread are machined with high positional accuracy into the framework-like side walls or onto the bottom mounting plates 13. For mounting the receiving units, the latter then need only be fixed by means of a fixing bolt onto the framework-like side walls or onto the mounting plates 13 or adapter plate 33 already mounted at the bottom. This dispenses with the need for the receiving unit to be aligned or correctly located by measuring. Merely a final measurement with a measuring record is necessary. If a receiving unit is not within the envisaged tolerance range, which occurs relatively rarely with the procedure described, after release it is correctly located by measuring in the conventional way and bolted in the required position by means of a precision socket on the fastening angle 35 and another precision bolt; subsequently, the precision socket is fixed with tacked spots on the fastening angle.

The welding station 2, 2′ also includes a universally usable part, that is a freely accessible mounting plate 30, which is likewise provided with sockets 14, 17, arranged to conform to the gridwork, and threaded bores 15. In order that the mounting plate 30, which is movable in a lifting manner, of the welding station 2, 2′ can be used universally—together with a standard adapter plate 33 which can only be used type-specifically—, it is made narrower in the transverse direction 24 than the narrowest vehicle body 21 and shorter in the longitudinal direction 3 than the shortest vehicle body. Fastened on this mounting plate 30 is the larger adapter plate 33, which is likewise provided with sockets 14, 17, arranged to conform to the gridwork, and threaded bores 15. With the aid of the insertion technique described, the adapter plate 33 is fixed in precise position on the mounting plate 30. The standard adapter plate 33 of the welding station can—as stated—only be used type-specifically. As exemplified by the bottom mounting plates 13 of the tacking station 1, it serves the purpose of receiving all the receiving units 18′ of the welding station in their entirety. The adapter plate 33 is therefore formed individually in terms of form and size on the basis of the area requirement for the arrangement of all the receiving units 18′ required at the bottom for the vehicle type to be produced and corresponds approximately to the outline contour of the vehicle type to be produced. When the receiving units are mounted in the welding station 2, 2′, it should likewise be taken into account that intermediate spaces must be left free for the frame legs 26 of the carrying skid 23 mentioned.

The body 21 received in the welding station 2, 2′ is merely secured on the underside and is otherwise freely accessible on all sides, which not only makes working easier when filling in the tacked components by welding, but also offers the possibility of changing the position of the body in terms of height during the welding and bringing it into a respectively ergonomically optimum position. For this purpose, the mounting plate 30 of the welding station 2, 2′ is arranged on the upper side of a lifting device 31, which is formed as a scissors-action lifting table and is surrounded by a bellows to protect the workers.

For further protection of the workers, arranged in the accessible region of the welding station 2, 2′—lying diametrically opposite each other—are two laser scanners 32, which are aligned with their sensing beam directed at the lifting device 31 and detect all objects in the area covered by the sensing beam. The horizontally arranged scanning level 34 is located approximately at calf height. The sensing beam covers an angular space of at least approximately 90 degrees. The laser scanner is coupled with the control of the lifting device in such a way that the latter can only be actuated if the laser scanner does not detect any objects other than the permanently installed lifting device, in particular legs of a worker. The lifting device can consequently only be actuated when all the workers have left the area covered by the laser scanner.

1. An installation for the precise mutual alignment and welding together of all the main, separate prefabricated components or large parts of a vehicle body hereafter referred to as “components” for short—to form a complete body shell during production of the prototype thereof, with the following design features of the installation:
at least one pair of stations with two workstations arranged one behind the other in the longitudinal direction and connected to one another in transporting terms by a conveying device are provided, the first workstation of which in the running-through direction, hereafter referred to as the tacking station, being intended and formed for the mutual alignment and tacking of the components and the second workstation of which, hereafter referred to as the welding station, being intended and formed for the filling-welding of the tacked components,
the tacking station has on the underside a horizontal, planar base plate and to the right and left in each case a vertical side wall which is movable transversely to the longitudinal direction on horizontal guiding rails and can be made to move between a lockable working position on the one hand and a moved-away loading position on the other hand and is formed as a bar framework, which side walls in the moved-together state can be connected at the upper side by detachable and fixable connecting bars to form a dimensionally stable cage, both the base plate and the two side walls being provided with a multiplicity of receiving units, which have been adapted to the vehicle type to be produced, for the positionally defined reception and secure clamping of the components within the tacking station,
the welding station likewise has on the underside a horizontal, planar mounting plate, which is likewise provided with a multiplicity of receiving units which have been adapted to the vehicle type to be produced and are intended for receiving in a positionally defined manner and securely clamping within the welding station the body shell which has already been tacked together from the components and bears its own weight and the forces occurring while it is being worked without deforming, the receiving units being restricted to the underside of the body shell to be clamped in such a way that the body shell received in the welding station is freely accessible from the sides, from the front, from the rear and from above,
both the tacking station and the welding station include on the one hand installation components and device parts which can be used universally, i.e. type-independently, and on the other hand installation components and device parts which can be used type-specifically, i.e. only for a specific vehicle type,
to be precise, the installation components or device parts stated below of the tacking station are formed in the following way for the purpose of universal usability of these components or parts:
the base plate is provided with a multiplicity of sockets arranged in a regular gridwork and threaded bores arranged in between, in a way corresponding to the same gridwork,
various rectangular, mounting plates, of various widths and/or lengths and machined such that they are plane-parallel, which can be assembled on the base plate and are intended for receiving a group of receiving units which are likewise provided with sockets matching the gridwork of the base plate and with bolt through-holes,
on both of the longitudinal sides of the base plate, guiding rails which are smoothly formed on the underside, can be mounted mirror-symmetrically on the latter and are likewise provided with sockets matching the gridwork of the base plate and bolt through-holes,
a number of carriages which can be made to move on a respective guiding rail, with in each case a vertically rising-up, flexurally rigidly supported assembly tree, which laterally has a vertical flat side facing the base plate, in which likewise at least two sockets, corresponding to the said gridwork, and threaded bores for the assembly of the framework-like side walls are arranged,
spigots, which exactly fit said sockets and are intended for setting out the parts to be assembled in precise position in relation to one another,
furthermore, of the installation components and device parts of the tacking station, the following components and parts can only be used type-specifically:
the two, already mentioned, distortion-resistant side walls, which are formed as two bar frameworks that are mirror-symmetrical to each other and are respectively machined plane-parallel on the opposite, vertical flat sides, are respectively roughly adapted with respect to the line followed by the bars to the line taken by the lateral contours and to the position of the A, B and/or C pillars of the vehicle type to be produced, the assembly bars leaving open apertures suitable for welding tools to pass through, which side walls are mounted onto the assembly trees of the transversely movable carriages and for this purpose are provided on the flat side facing the assembly trees with sockets, arranged to conform to the gridwork, and bolt through-holes, and which side walls furthermore are plane-machined on the upper side in a horizontal plane at at least two locations and provided there with a socket or spigot and with a connecting element,
connecting bars, which correspond in their length to the spacing between the side walls locked in the working position and are plane-machined on the underside at their ends and provided there with a spigot or a socket and with a connecting element for connection on the upper side to the side walls,
a number of receiving units, which are adapted to the vehicle type to be produced, are mounted on the side walls, project at right angles from them and are respectively provided with a number of adapted receiving locations and a movable clamping arm,
furthermore, a number of receiving units, formed as exemplified by the receiving units of the side walls and mounted on the bottom mounting plates, the intermediate spaces remaining between the mounted receiving units being arranged in such a way that, to accept the vehicle body produced, the frame legs of a carrying skid can be lowered in the vertical direction into the intermediate spaces and lifted out of them without hindrance,
the welding station includes as a universally usable component a freely accessible mounting plate with sockets, arranged to conform to the gridwork, and threaded bores, and as components which can only be used type-specifically, a number of receiving units, which are formed and arranged as exemplified by the receiving units of the bottom mounting plates of the tacking station, with interposition of an adapter plate, and likewise leave intermediate spaces for the frame legs of the carrying skid mentioned.

2. The installation as claimed in claim 1, wherein the gridwork mentioned, decisive for the position of the sockets and threaded bores, is formed in an orthogonal manner and has the same grid spacing in the horizontal longitudinal directions and transverse direction and also in the vertical direction.

3. The installation as claimed in claim 2, wherein the horizontal outside dimensions of the mounting plates are made to correspond in the longitudinal direction and transverse direction to the mentioned gridwork, which is decisive for the position of the sockets and threaded bores, and in that the sockets and threaded bores in the mounting plates are arranged eccentrically by half the grid spacing in relation to the delimiting edge of the mounting plates lying parallel to the transverse direction.

4. The installation as claimed in claim 2, wherein system lines following the gridwork are machined in the base plate or in the mounting plate of the tacking station and the welding station and in the mounting plate or adapter plate of both stations.

5. The installation as claimed in claim 4, wherein straight system lines machined in the base plate or in the mounting plate and in the adapter plates or adapter plate run centrally through the sockets and the threaded bores.

6. The installation as claimed in claim 1, wherein two pairs of stations respectively comprising a tacking station and a welding station are arranged directly one behind the other in a standard production line, and are connected to one another in transporting terms, the first pair of stations being formed for the mutual alignment and tacking of the components including the right and left side walls, arranged in the interior of the body, and the second pair of stations being formed for the subsequent alignment and tacking of the two exterior side walls.

7. The installation as claimed in claim 1, wherein, for accepting the vehicle body produced, the carrying skid constructed in a frame-like manner secures it with vertical play but such that it is prevented from slipping horizontally, two longitudinally running frame legs of the carrying skid respectively protruding beyond the vehicle body at the front and rear in the longitudinal direction and being provided at the ends with lugs for attaching crane tackle.

8. The installation as claimed in claim 1, wherein the conveying device for connecting the workstations in transporting terms is formed as a gantry crane installation, the crane tackle attached to its load hook comprising a cross member running in the longitudinal direction, with load-bearing cables attached to both ends.

9. The installation as claimed in claim 1, wherein the receiving units adapted to the vehicle type to be produced for the positionally defined reception and secure clamping of the components within the individual workstations are in principle constructed identically to one another and respectively comprise the following components:
a fastening angle, which is identically formed for all the receiving units and can be bolted onto the load-bearing underlying surface,
a supporting plate, which can be bolted onto the fastening angle, projects from the load-bearing underlying surface and is formed with its contour that is facing the vehicle body individually in a way corresponding to the respective local outline contour of the body part on the outer side of the latter, and is in “point” contact with the latter at at least two receiving locations, the length of the supporting plate from the fastening angle to the punctiform receiving locations corresponding to the individually required distance of the body part from the load-bearing underlying surface,
a clamping arm, which is pivotably fastened to the end of the supporting plate on the body side, lies in the plane of the supporting plate, reaches in a jaw-like manner over the body part to be securely clamped, is individually shaped on its inner side in a way corresponding to the respective local outline contour of the body part and, at the location which corresponds in the closed state to a receiving location of the supporting plate, is respectively provided with a shape-adapted clamping thumb,
furthermore, a tensioner for the rapid pivoting closed and locking of the clamping arm in the closed state.

10. The installation as claimed in claim 1, wherein the traveling path of the framework-like side walls carried by the guiding rails and the carriages between the working position and the moved-away loading position is at least approximately 60 cm, preferably at least approximately 100 cm.

11. The installation as claimed in claim 1, wherein the guiding rails mounted on both of the longitudinal sides of the base plate protrude laterally beyond the base plate and are supported in the part protruding beyond the base plate by separate, height-adjustable supports.

12. The installation as claimed in claim 1, wherein the sockets, attached to the assembly tree of the carriage to conform to the gridwork in the vertical direction, are arranged as a reference plane above the surface of the base plate by an integral multiple, taking into account the common overall height of the guiding rail mounted laterally on the longitudinal sides of the base plate and taking into account the carriage which can be made to move on said rail.

13. The installation as claimed in claim 1, wherein the working position of the framework-like side wall which can be made to move on the guiding rail and the carriage is secured by a stop mounted on the base plate and can be fixed by a tensioner.

14. The installation as claimed in claim 1, wherein the connecting elements between the connecting bars and the two opposite side walls are respectively formed as quick-action closures.

15. The installation as claimed in claim 1, wherein at least three separate sockets, which are known exactly in respect of their position and into which a measuring instrument for spatially measuring the decisive points of the tacking station can be fixed, are embedded in the surface of the base plate of the tacking station.

16. The installation as claimed in claim 1, wherein the mounting plate of the welding station is arranged on the upper side of a lifting device.

17. The installation as claimed in claim 16, wherein the lifting device carrying the mounting plate of the welding station is formed as a scissors-action lifting table.

18. The installation as claimed in claim 16, wherein arranged in the accessible region of the welding station—lying diametrically opposite each other—are two laser scanners, which are aligned with the lifting device (31), with a horizontal scanning level and a coverage angle of at least 90°, the scanning level being arranged approximately at calf height.

19. The installation as claimed in claim 16, wherein the lifting device of the welding station is surrounded by a bellows.

20. The installation as claimed in claim 16, wherein the mounting plate, which is movable in a lifting manner, of the welding station is made narrower in the transverse direction than the narrowest vehicle body and shorter in the longitudinal direction than the shortest vehicle body and in that fixed in precise position on this mounting plate is a uniform adapter plate corresponding individually in terms of form and size to the area requirement for the arrangement of receiving units for the adapter plate corresponding to the vehicle type to be produced.

21. The installation as claimed in claim 20, wherein the adapter plate of the welding station corresponds approximately to the outline contour of the vehicle type to be produced.

22. An installation for production of vehicle body prototypes, comprising:
a tacking station having a support cage for supporting vehicle body components in position inside said cage while providing access openings in said cage for tack welding said body components together to form a self supporting tack welded vehicle body, and
a welding station for accommodating finish welding of said tack welded vehicle body, said welding station including:
support clamps engageable only with an underside of said tack welded vehicle body to thereby leave substantially free access to all sides of the tack welded vehicle body for finish welding of said vehicle body components to one another,
wherein said tacking station and welding station are of modular construction with plug and connection opening grids accommodating exchange of station parts for production of respective different vehicle body prototype configurations.

23. An installation according to claim 22, wherein said tacking station includes:
a horizontal planar base plate,
horizontal guide rails detachably connectible to the base plate,
cage side walls slideably movable along said guide rails between respective vehicle body component loading positions, and
detachable connection bars operable to connect upper parts of the cage side walls to form a dimensionally stable cage.

24. An installation according to claim 23, wherein said cage side walls are movable between said loading and working positions by a distance greater than 60 cm.

25. An installation according to claim 23, comprising a measuring instrument for spatially measuring and fixing tacking points, said measuring instrument being supported at at least three separate sockets embedded in said base plate at predetermined positions.

26. An installation according to claim 22, comprising laser scanning means in the area of the welding station for detecting presence of workers.

27. An installation according to claim 22, wherein said welding station includes:
a horizontal planar mounting plate for detachable mounting of a plurality of said support clamps.

28. An installation according to claim 23, wherein said welding station includes:
a horizontal planar mounting plate for detachable mounting of a plurality of said support clamps.

29. An installation according to claim 22, wherein first and second pairs of said tacking and welding stations are arranged directly behind one another in a production line, the first of said pair of stations being configured for subsequent alignment and welding of exterior side walls.

30. An installation according to claim 28, wherein first and second pairs of said tacking and welding stations are arranged directly behind one another in a production line, the first of said pair of stations being configured for subsequent alignment and welding of exterior side walls.

31. An installation according to claim 22, wherein the plug and connection grids are formed in an orthogonal manner with similar grid spacings in respective different orthogonal directions.

32. An installation according to claim 27, wherein the mounting plate is movable in a lifting vertical direction and is narrower in a transverse direction than a narrowest of vehicle body prototypes to be produced and shorter in a longitudinal direction than a shortest of vehicle body prototypes to be produced, and
wherein a uniform adapter plate is fixed in a precise position on the mounting plate, said adapter plate being configured to accommodate a pattern of said support clamps corresponding to a respective particular vehicle body type being produced.

33. An installation according to claim 32, wherein said adapter plate has an outline contour conforming approximately to an outline contour of the vehicle body type being produced.

34. A method of making a prototype vehicle body using the installation of claim 22, comprising:
holding vehicle body components in position in said tacking station while tack welding said components together to form said tack welded vehicle body,
transferring the tack welded vehicle body to said welding station and engaging said support clamps to hold the tack welded vehicle body in position, and
finish welding said vehicle body component together.
